(19) United States
(12) Patent Application Publication
(10) Pub. No.: US 2014/0102258 A1
(43) Pub. Date: Apr. 17, 2014

(54) Methods for Extrusion Die Housing and Insert

(71) Applicant: New England Wood Pellet LLC, Jaffrey, NH (US)

(72) Inventor: Steven J. Walker, Jaffrey, NH (US)

(73) Assignee: New England Wood Pellet LLC, Jaffrey, NH (US)

(21) Appl. No.: 14/134,187

(22) Filed: Dec. 19, 2013

Related U.S. Application Data
(62) Division of application No. 13/248,631, filed on Sep. 29, 2011.

(51) Int. Cl. B23P 19/10

(52) U.S. Cl. CPC B23P 19/10
USPC 76/107.4

(57) ABSTRACT

A method for manufacturing an extrusion die is presented. A die housing having an exterior surface and an inner interface surface is formed. A die insert having an outer interface surface and an extrusion surface is formed. The die housing is configured to removably receive the die insert so that the outer interface surface is adjacent to the inner interface surface. The inner interface surface is configured to substantially enclose the outer interface surface.

### CROSS-REFERENCE TO RELATED APPLICATIONS

This application is a divisional of and claims the benefit of U.S. patent application Ser. No. 13/248,631, filed Sep. 29, 2011, entitled “Extrusion Die Housing and Insert,” which is incorporated by reference herein in its entirety.

### FIELD OF THE INVENTION

The present invention relates to extrusion mills, and more particularly, is related to pellet mills using extrusion techniques.

### BACKGROUND OF THE INVENTION

Extrusion-type pellet mills and the process of producing pellet material using such devices are well known in the art. In pellet mills, a mixture of material to be pelleted, or “feed,” is typically fed to a die having a plurality of extrusion holes. Pellets are generally formed when the feed is compressed and molded between a pressure roll and an extrusion die.

During the extrusion process, generally one or more extrusion rolls travel over the compression side of the die and force the material between the die and the rolls. This movement squeezes the material through extrusion holes in the die. As the material emerges from the discharge side of the die, the extrusions are severed to produce pellets. Other parts of the pellet mill may facilitate the continuous compression of feed between the pressure rolls and the die and the handling of the extruded pellets.

Each pellet mill is generally equipped with a die and roll assembly which often includes a plurality of pressure rolls, an extrusion die, and a mechanism for delivering feed material evenly along an inner interface surface of the extrusion die so that the feed can be compressed by the pressure rolls when they roll over the inner interface surface of the die. The inner interface surface of the die is also known as the compression surface or the extrusion surface.

FIG. 1A is a simplified diagram of a prior art pellet mill 100. The pellet mill 100 in FIG. 1 is an example of a common pellet extrusion mill. A die cover 111 is shown in an open position displaying a ring die 110 that is mounted upon a main shaft 120. The ring die 110 rotates around the main shaft 120. The ring die 110 is affixed to a die housing 115. The die housing 115 is fixed to bearings (not shown) that are mounted to the main shaft 120. Therefore, the die housing 115 along with the ring die 110 rotates in accompaniment with the main shaft 120. Alternatively, the main shaft 120 may be fixed, and the ring die 110 may be driven by an external motor 112 via, for example, a belt 113, or an external friction roller (not shown) in contact with the exterior of the ring die 110. The inner and outer interface surfaces of the ring die 110 contain a plurality of extrusion holes 130. The feed material is fed into the ring die 110 by, for example, an auger 165, and forced into the extrusion holes 130 on the extrusion surface of the ring die 110, and emerges from the extrusion holes 130 on the exterior portion of the ring die 110. The extruded material may then be cut, for example, with a blade (not shown) to size pellets.

The feed in the pellet mill 100 is forced through the extrusion holes 130 by multiple rolls 140. Note that while three rolls 140 are depicted in FIG. 1A, prior art pellet mills may have one, two, three, four, or more rolls. Each roll 140 is freely rotating around a roll shaft 160, and each roll 140 is mounted on a carriage 150 (FIG. 2). The carriage 150 (FIG. 2) may be stationary, or may be driven to rotate around the main shaft 120. When feed is introduced to the interior of the ring die 110 by a feed path, for example, by the auger 165, attached to a die cover 111, the feed is driven toward the rolls 140. Note that in FIG. 1A the auger 165 is shown as separated from the rolls 140, that is, with the cover open, for the purpose of clarity. When the die cover 111 is closed over the ring die 110, as shown in FIG. 1B, the auger 165 is positioned in the center of the ring die 110 so that the auger 165 may distribute feed material to the rolls 140.

In general, the rolls 140 do not come into direct contact with the inner interface surface of the ring die 110. Each roll 140 is separated from the ring die 110 by a pinch gap 170, as shown in FIG. 2. In order to provide optimum performance, it is desirable to monitor the size of the pinch gap 170 between the roll 140 and the die 110, and further to adjust the pinch gap 170 size as needed. For example, there may be variations in consistency of the feed over time, requiring either more or less pinch gap 170 pressure between the roll 140 and die 110 for optimum performance, and to compensate for wear and/or abrasion on the roll 140 and die 110.

It is desirable to maximize production of pellets over a period of time. However, the need for frequent die maintenance may limit pellet production efficiency. In particular, where it is desirable for the die to be fabricated from materials that resist wear and abrasion for maximum pellet cutting efficiency, these characteristics may be compromised in favor of materials with adequate die structural support and rigidity characteristics. FIG. 3 is an exploded view of a prior art ring die 300, and FIG. 4 shows the prior art ring die 300 as assembled. In order to facilitate a path for the extruded pellets to pass through extrusion holes 330 in the ring die 310, support members are located at the edges of the ring die 310. Such support members may include a die housing 320 and a stiffener ring 340. The die housing 320 and stiffener ring 340 may be attached to the ring die 310, for example, with bolts 350.

High pressure on the section of the ring die 310 that is unsupported by the housing 320 or the stiffener ring 340 may result in the ring die 310 cracking or breaking. In some cases, the ring die 310 may split, causing a portion of the die attached to the stiffener ring to separate, causing significant damage to the rest of the machine. Replacing a cracked or broken die may be costly and time consuming, as the mill is disassembled and the stiffener ring 340 and die housing 320 are re-attached to the replacement ring die 310. Therefore, there is an unmet need for an extrusion ring die having improved structural rigidity characteristics, that may be serviced less frequently than previous pellet mills, and that may be serviced with minimal time and expense.

### SUMMARY OF THE INVENTION

Embodiments of the present invention provide methods for an extrusion die housing and insert. Briefly described in architecture, a first aspect of the present invention is directed to a method for manufacturing an extrusion die having the steps of forming a die housing having an exterior surface and an inner interface surface, and forming a die insert having an outer interface surface and an extrusion surface, the die housing configured to removably receive the die insert so that the outer interface surface is adjacent to the inner interface surface. The method may further include the steps of forming a plurality of extension apertures between the exterior surface and the inner interface surface, and forming a plurality of extrusion apertures between the outer interface surface and the extrusion surface, wherein the plurality of extension apertures align with the plurality of extrusion apertures.

A second aspect of the present invention is directed to a method for manufacturing an extrusion die insert configured to be removably received by a die housing having an exterior surface and an inner interface surface. A die insert having an outer interface surface and an extrusion surface is formed, with the die housing configured to removably receive the die insert so that the outer interface surface is adjacent to the inner interface surface. A plurality of extrusion apertures between the outer interface surface and the extrusion surface are formed. The plurality of extension apertures align with a plurality of extrusion apertures formed in the die housing.

A third aspect of the present invention is directed to a method for servicing an extrusion die, the extrusion die having a die housing having an exterior surface and an inner interface surface, the die housing configured to removably receive a die insert, and a first die insert having an outer interface surface and an extrusion surface, the first die insert disposed within the die housing so that the outer interface surface is adjacent to the inner interface surface. The first die insert in the die housing by removing the first die insert from the die housing is replaced, and a second die insert into the die housing is installed. In one embodiment, the second die insert has characteristics more favorable to a specific extrusion material with respect to the first die insert.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1A is a schematic diagram of a prior art pellet mill with a ring die and passive rolls with the die housing open for clarity.

FIG. 1B is a schematic diagram of the prior art pellet mill with the die housing closed.

FIG. 2 is a schematic diagram of a detail of the pinch gap of the prior art pellet mill of FIG. 1A.

FIG. 3 is a schematic diagram of a prior art ring die in exploded view.

FIG. 4 is a schematic diagram of a prior art ring die as assembled.

FIG. 5 is a schematic diagram of a first embodiment of an extrusion die and die insert in exploded view.

FIG. 6 is a schematic diagram of a first embodiment of an extrusion die and die insert, as assembled.

FIG. 7A is a sectional schematic diagram of a prior art ring die.

FIG. 7B is a sectional schematic diagram of the first embodiment of the ring die and housing.

FIG. 8 is a schematic diagram of a second embodiment of a ring die housing and insert shown in exploded view.

FIG. 9 is a schematic diagram of a second embodiment of a ring die housing and insert shown as assembled.

FIG. 10 is a schematic diagram of a third embodiment of a die housing and die insert with an alternative keying mechanism.

FIG. 11 is a sectional schematic diagram of a fourth embodiment of a die housing and die insert.

FIGS. 12A-12C are sectional schematic diagrams of a detail of an extrusion hole and an extension hole.

FIG. 13 is a schematic diagram of a fifth embodiment of a die housing and die insert.

FIG. 14A is a schematic diagram of a prior art flat die from a sectional view.

FIG. 14B is a schematic diagram of a fifth embodiment of a die housing and die insert from a sectional view.

FIGS. 15A and 15B are schematic diagrams of a fourth embodiment of a die housing and die insert in exploded and assembled views.

FIG. 16 is a schematic diagram of a sixth embodiment of a die housing and die insert.

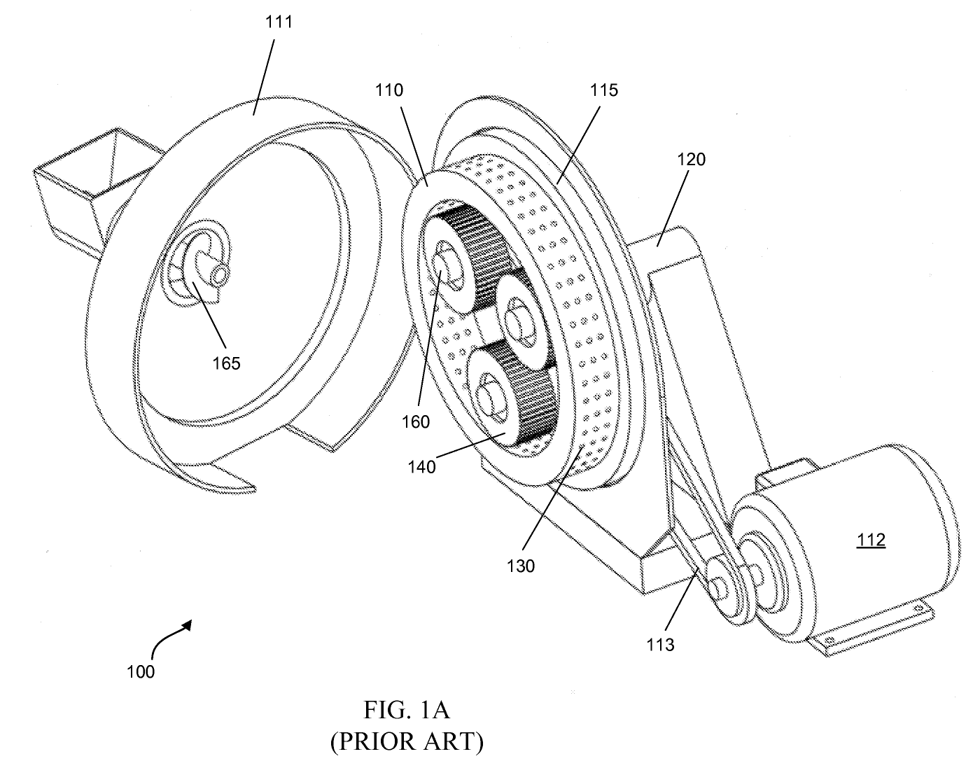

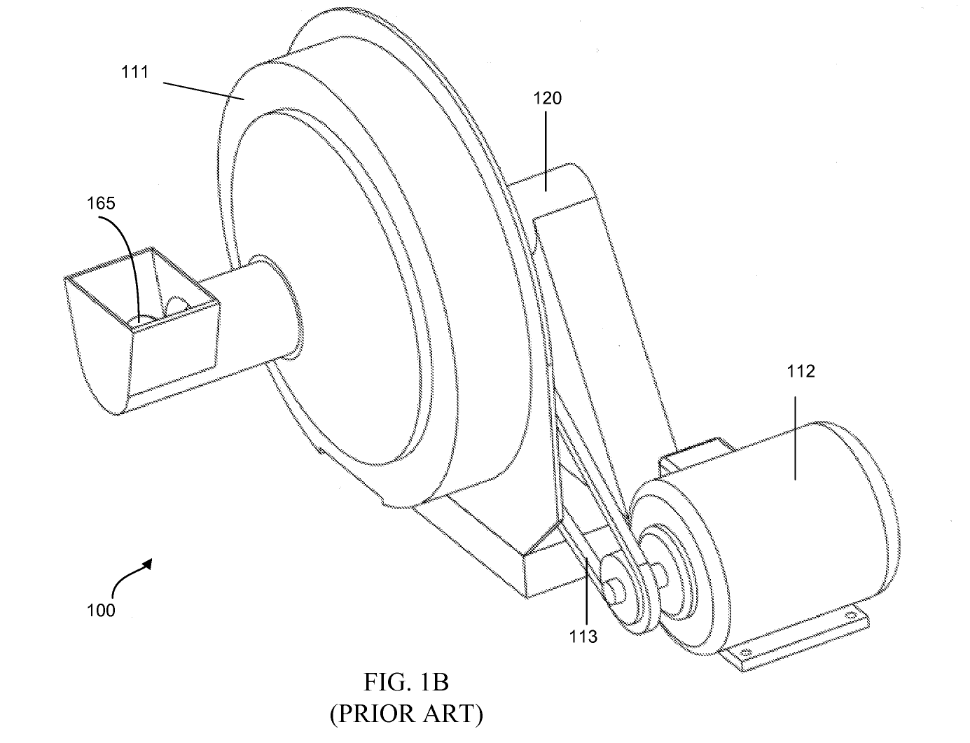

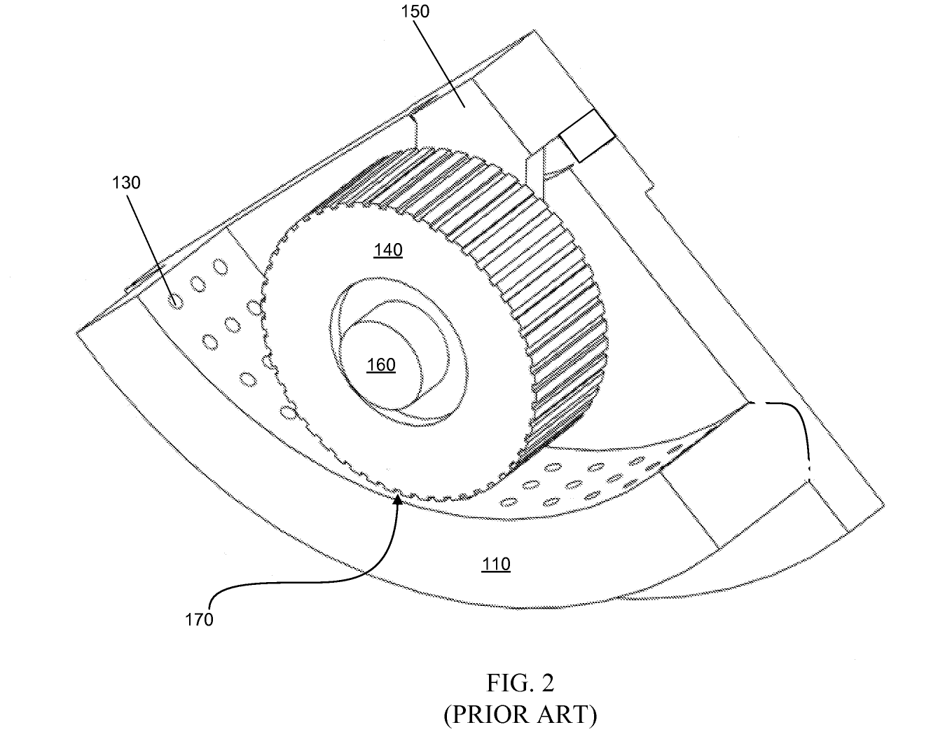

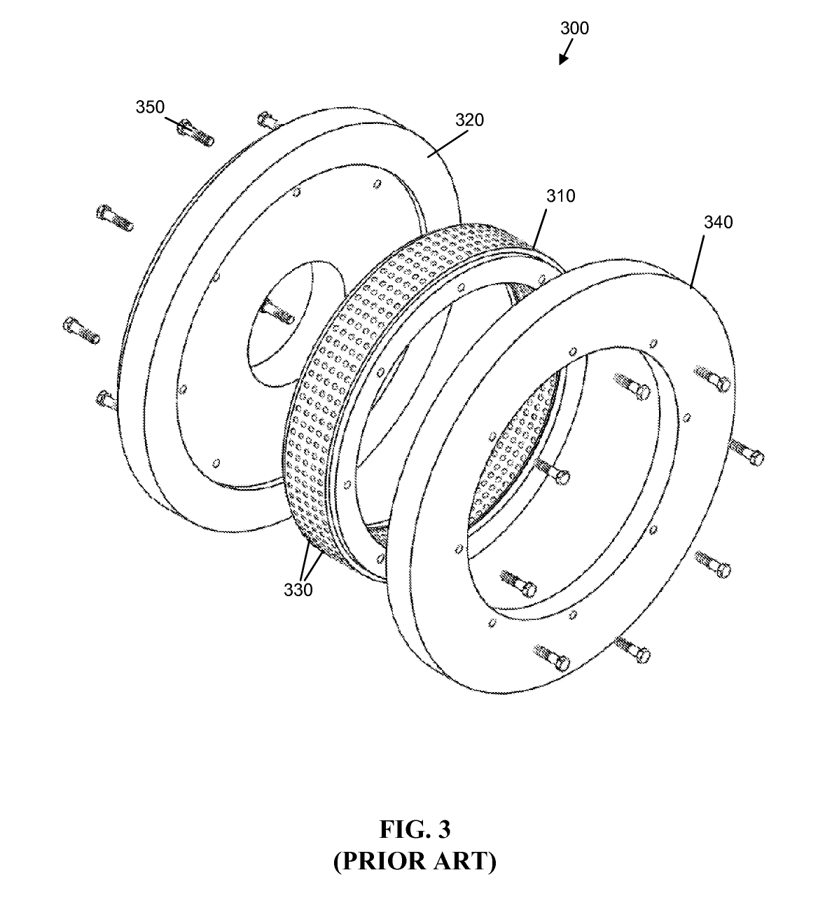

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

In general, embodiments of an extrusion die housing with a removable and replaceable die insert are presented. The die insert is received by the die housing, such that the extrusion surface of the die insert is generally supported by the die housing. Material inside the die is compressed by rolls located generally on the interior of the die, so that compressed material is forced through extrusion holes in the die insert, thereafter passing through extension holes in the die housing, where the extension holes axially align with the extrusion holes.

Ring Die Embodiment

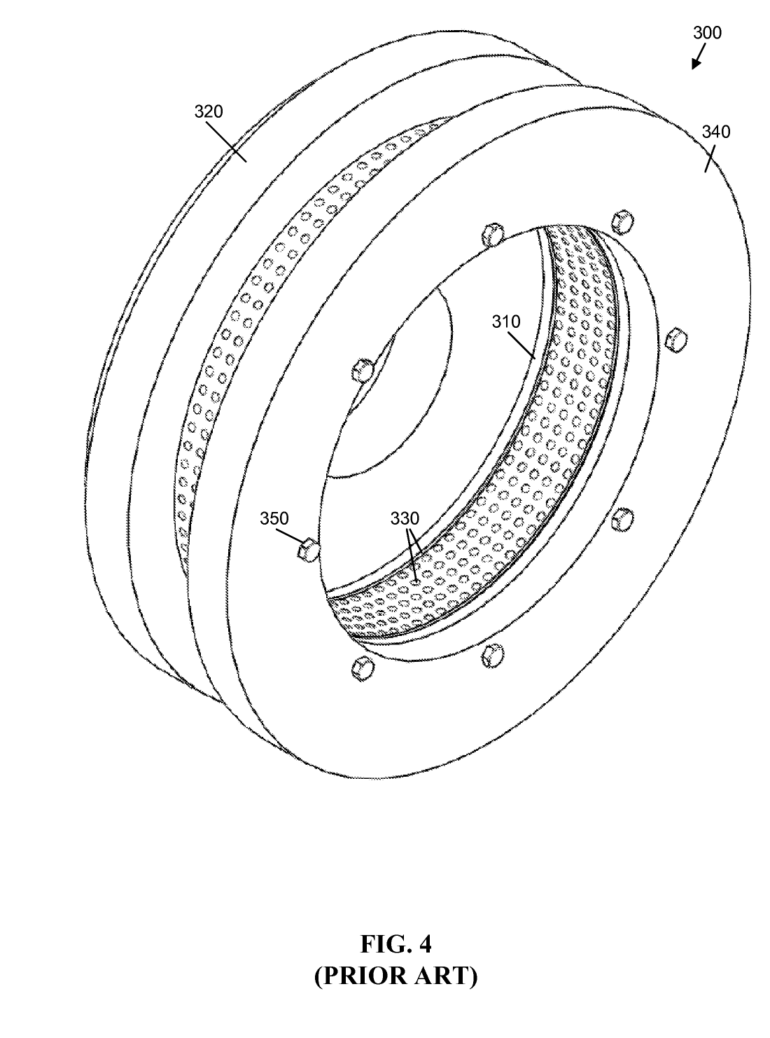

A first embodiment of an extrusion die 500 with a housing and insert is shown, in an exploded view, in FIG. 5. It should be noted that while the extrusion die housing and insert are shown in the first embodiment as a ring die, there is no objection to other forms of extrusion dies, for example, a flat die.

The die housing 520 has an exterior surface 560, and an inner interface surface 562. A plurality of extension holes 535 or apertures pass from the inner interface surface 562 through to the exterior surface 560. A die insert 510 has an outer interface surface 564 and an extrusion surface 566 on the interior of the die insert 510. A plurality of extrusion holes 530 or apertures pass from the extrusion surface 566 through to the outer interface surface 564. The die housing 520 is formed to receive the die insert 510. When the die insert 510 is inserted into the die housing 520, the insert outer interface surface 564 is adjacent to the die housing inner interface surface 562, so that the extrusion holes 530 axially align with the extension holes 535, for example, to within a given tolerance. Pellets may be formed by forcing material from within the die insert 510 interior through the extrusion holes 530 in the extrusion surface 566, whereafter the pellets pass through the extension holes 535 to the die housing exterior 560. Pellets may be cut or broken off outside the die housing exterior surface 560.

The die insert 510 and the die housing 520 may be formed with a taper with respect to the insert outer interface surface 564 and the housing inner interface surface 562 to allow for easier installation of the die insert 510 into the die housing 520 and an interference fit. This taper may be set, for example, so that as the die insert 510 is inserted further into the die housing 520, the fit becomes tighter. The die extrusion holes 530 may be made similar to prior art dies, for example, with a counter bored relief. The die housing 520 extension holes 535 may be slightly larger in diameter than the extrusion holes 530 in the die insert 510 to minimize restrictions of the material extruding from the interior of the extrusion die 500. Extrusion holes 530 and extension holes 535 are discussed in further detail below.

The die housing 520 may contain a back 570 adjacent to an inner edge 575 of the die insert 510 when assembled. The back 570 may assist in maintaining an axial alignment between the extrusion holes 530 and the extension holes 535. In alternative embodiments, the back 570 may include a slot (not shown) to receive the insert 510, and the slot (not shown) may, for example, be keyed or grooved or threaded to hold the insert 510 in rigid rotational alignment with the housing 520. The back 570 may be attached to a main shaft (not shown), and the main shaft may be held in a bearing (not shown) and used to rotate the die housing 520.

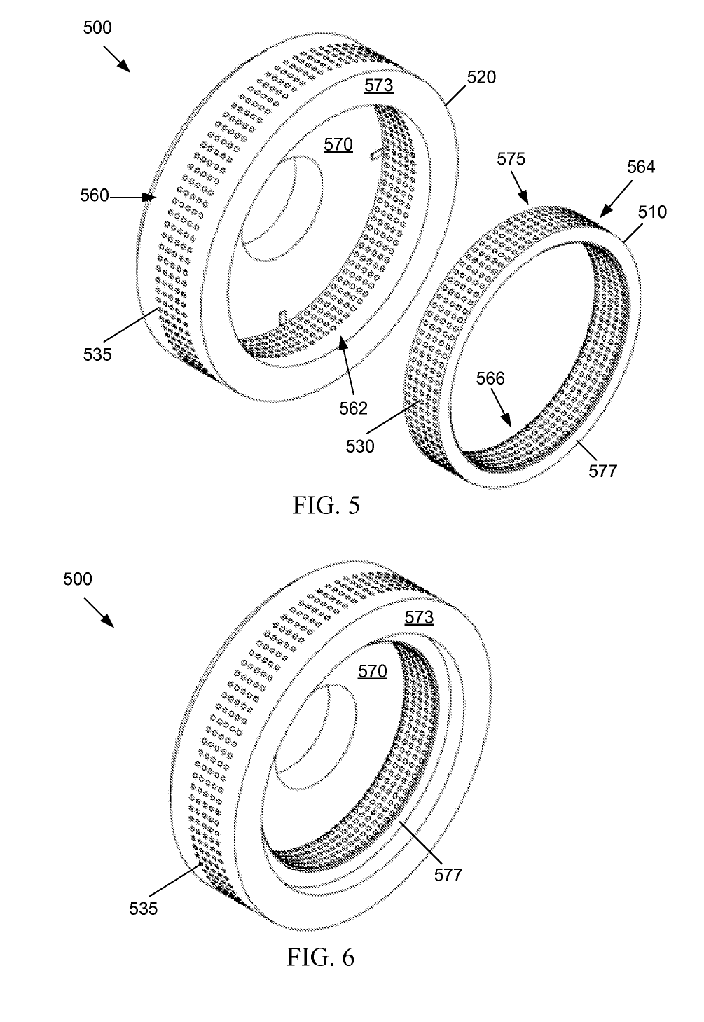

The assembled extrusion die 500 is shown in FIG. 6. As shown, a die insert outer edge 577 is inset from a die housing outer edge 573. However, there is no objection to the die insert outer edge 577 being flush with the die housing outer edge 573, or to the die insert outer edge 577 being extending past the die housing outer edge 573.

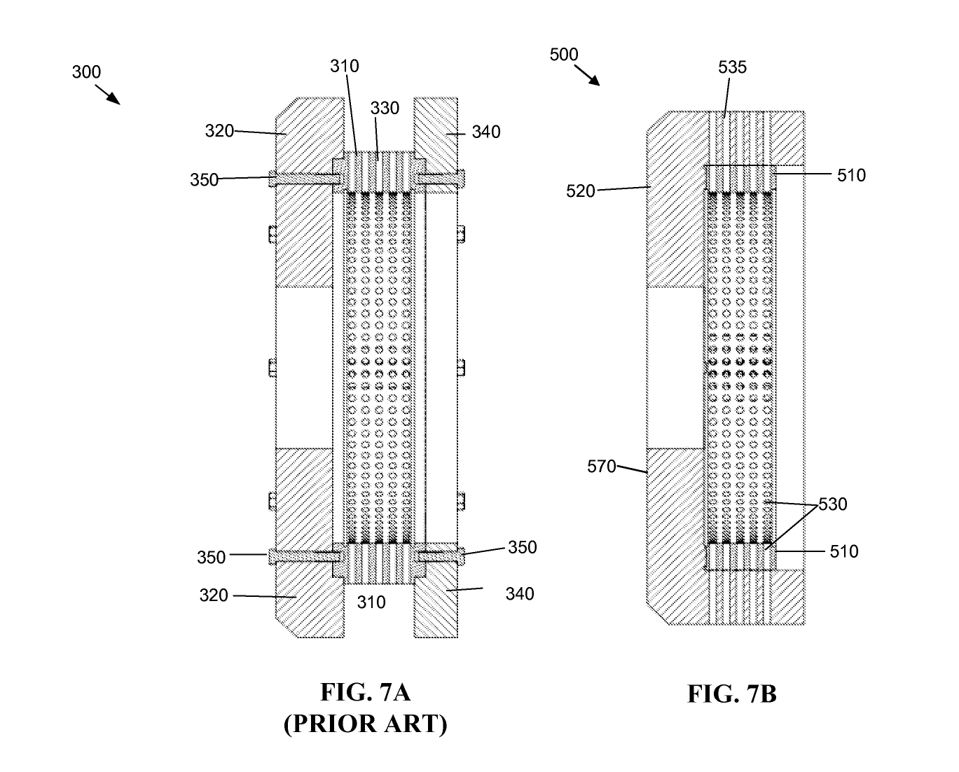

FIGS. 7A and 7B show a cross section comparison between a prior art ring die 300 and the first embodiment of the ring die and housing 500. The prior art ring die 300 shown in FIG. 7A may include one or more rollers (not shown) within the die 300, where the roller rotates on a roller shaft (not shown). Pellet material is compressed between the roller and the ring die 310, forcing pellets through the extrusion holes 330. The die housing 320 contains and supports a first edge of the ring die 310, and the stiffener ring 340 supports and contains a second edge of the ring die 310. In general, the roll surface extends across the entire extrusion surface of the ring die 310, including areas where there are no extrusion holes 330 where the ring die 310 is supported by the die housing 320 and the stiffener ring 340.

In contrast, under the first embodiment shown in FIG. 7B, the die housing 520 provides backing support to at least a portion of the width of the extrusion area of the die insert 510. As a result, the die insert 510 may be thinner than the prior art ring die 310 (FIG. 7A), as it need not provide as much structural support against the pressure of the extrusion material between the die insert 510 and the roll. The edges of the prior art die 300 (FIG. 7A) are used as contact area for support by the die housing 320 (FIG. 7A) and stiffener ring 340 (FIG. 7A), and therefore extrusion holes 330 (FIG. 7A) are inset from the edges of the ring die 310 (FIG. 7A). Hence, the extrusion surface of the die insert 510 may be narrower than the extrusion surface of the prior art ring die 310 (FIG. 7A), as the ring die insert extrusion area may include extrusion holes 530 closer to the edges. By extension, the roll (not shown) may have less surface area in the first embodiment than under the prior art. Therefore, considerably less material may be used for the ring die insert 510, since the die insert 510 may be both narrower and thinner than the prior art ring die 310 (FIG. 7A). Furthermore, the die insert 510 may be considered a consumable part, while the die housing 520 generally is not consumable, and, over time, the same die housing 520 may house several die inserts 510 as the die inserts 510 are worn and replaced.

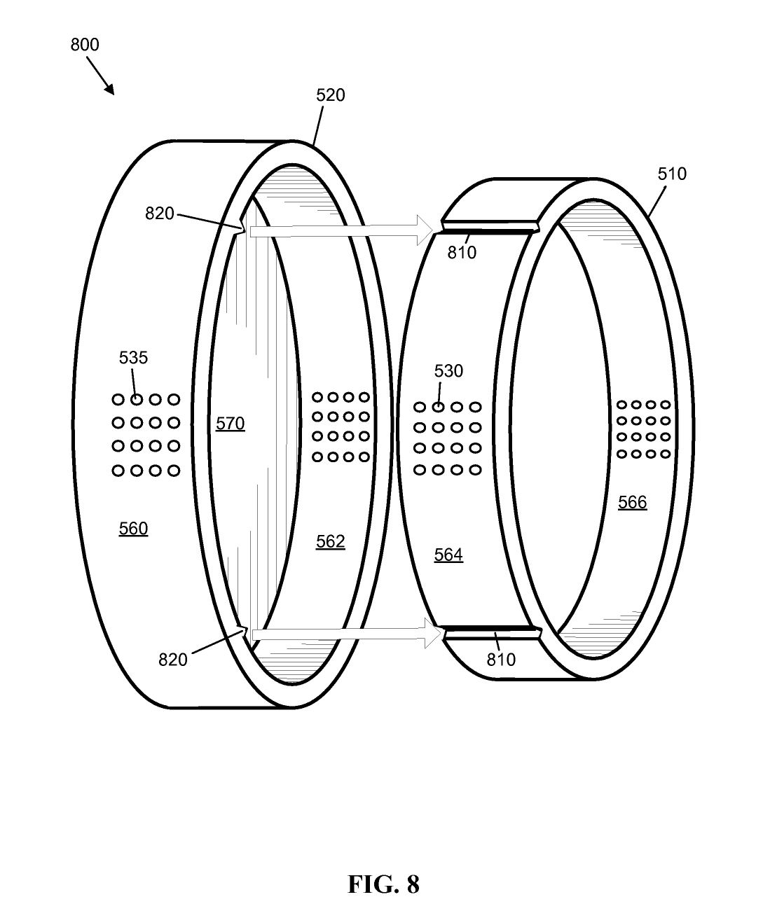

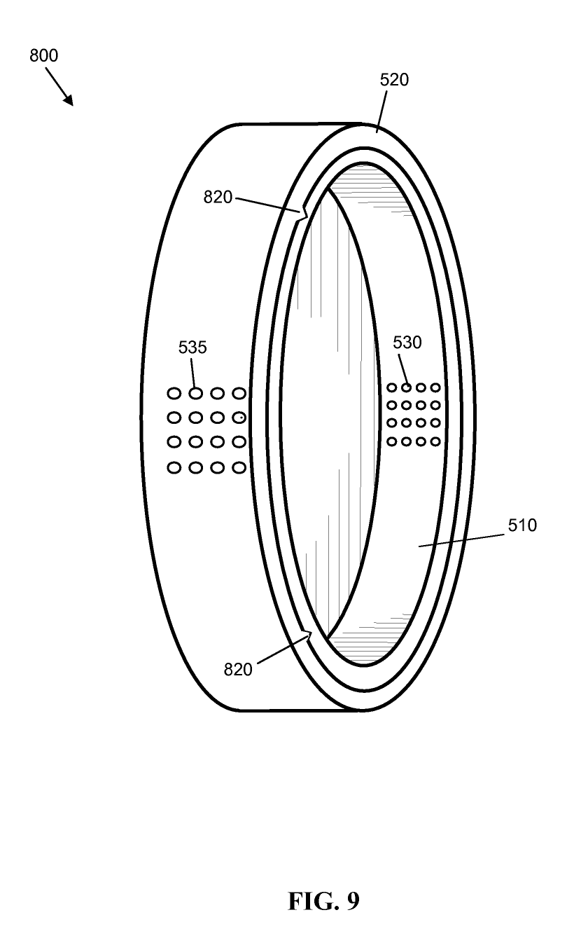

In order for the extruded material to pass through both the extrusion holes 530 in the die insert 510 and the die housing 520 extension holes 535, the extrusion holes 530 and the extension holes 535 need to remain generally axially aligned. FIG. 8 is a schematic diagram of a second embodiment 800 of a ring die housing and an insert. Under the second embodiment, the ring die housing 520 and ring die insert 510 are keyed to ensure alignment. Under the second embodiment, a key ridge 820 extends inward from the die housing 520 inner interface surface 562. A corresponding key slot 810 is inset in the die insert 510 outer interface surface 564. When the die insert 510 is slid into the die housing 520, the key ridge 820 fits into the key slot 810, thereby preventing rotation of the die insert 510 in relation to the die housing 520, as shown in FIG. 9.

It should be noted that while FIGS. 8 and 9 show two key ridges 820 and two key slots 810, there is no objection to more or fewer key slots 820 and key ridges 810. Also, while, as depicted, the key slots 820 and key ridges 810 are relatively large in comparison with the extrusion holes 530 and extension holes 535, there is no objection to smaller or larger key slots 810 and key ridges 820. Further, while the key ridges 820 and key slots 810 are depicted as generally horizontally oriented, there is no objection to disposing key ridges 820 and key slots 810 substantially at an angle, for example, to facilitate arrangements of extrusion holes 530 that may be similarly angled. Similarly, there is no objection to an embodiment positioning key ridges 820 on the die insert 510, and key slots 810 on the die housing 520.

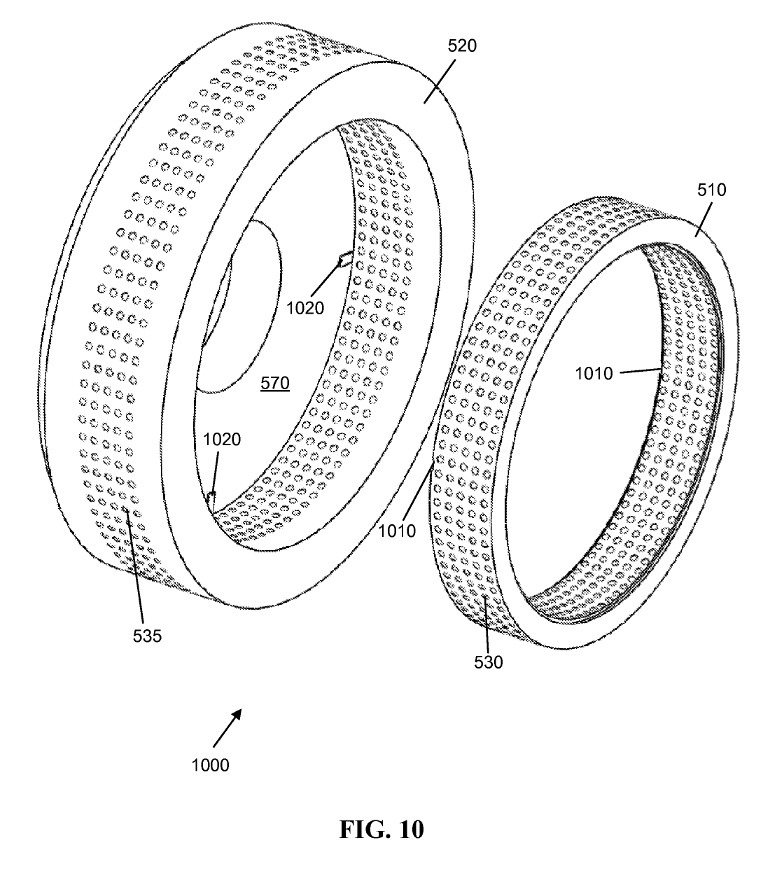

It may be desirable for the keying mechanism between the die housing 520 and the die insert 510 to be situated apart from the extrusion holes 530 and extension holes 535. FIG. 10 is a schematic diagram of a third embodiment 1000 of a die housing and die insert with an alternative keying mechanism. Under the third embodiment, a key tab 1020 extends from the back 570 of the die housing 520, corresponding to a key slot 1010 in the edge of the die insert 510.

It should be noted that other variations of keying between the die insert 510 and the die housing 520 are within the scope of this disclosure. For example, there is no objection to keys protruding outward from the die insert 510 and corresponding key holes within the die housing 520. Similarly, there is no objection to the keys being separate from the die insert 510 and die housing 520, for example, removable pins or bolts used to hold the die insert 510 in alignment with the die housing 520.

Under normal operation, the die insert 510 may be operated until the die insert 510 needs to be replaced, due to, for example, wear and/or abrasion. In some circumstances, a first die insert 510 may be replaced in favor of a second die insert 510 with characteristics more favorable to a specific extrusion material. For example, the second die insert 510 may have different extrusion hole 530 sizes or tapers than the first die insert 510. The die insert 510 may be removed from the die housing 520, and thereafter replaced by a new die insert 510. Replacement of a die insert 510 may be generally less time and labor intensive than replacement of a prior art ring die.

The material used to form the die insert 510 may be optimized for qualities needed for forming pellets against extrusion rolls, for example, hardness and low wear and/or abrasion characteristics. An example of a preferable material having superior wear characteristics for the die insert 510 includes a high chrome stainless steel alloy. The material used to form the die housing 520, in contrast, may be optimized for structural strength and stability, for example, rigidity and stiffness. An example of a preferable material for the die housing 520 includes a carbon alloy steel, such as 4140 steel. It is preferable that the material for the die housing 520 and the die insert 510 have generally proportional thermal expansion rates, for example, to maintain alignment between the die housing 520 and die insert 510 over a range of operating temperatures.

As mentioned above, by individually optimizing the structural characteristics of the housing 520 and wear characteristics of the insert 510, the overall mass of the extrusion die may be reduced relative to the extrusion surface area, when compared to prior art extrusion dies. It should be noted that while the relative thickness of the die housing 520 and die insert 510 may be generally equal in some embodiments, there is no objection to embodiments having other proportions, for example, a relatively thick die housing 520 with a relatively thin die insert 510, or a relatively thin die housing 520 with a relatively thick die insert 510.

The thickness of the die housing 520, corresponding to the length of the extrusion holes 535, may be determined based upon, for example, the density of extrusion holes 530 and extension holes 535 in relation to extrusion surface area of the die insert 510. For example, if there is a high density of extrusion holes 530, there is a correspondingly high density of extension holes 535. A higher density of holes 530, 535 may result in the need for a thicker die housing 520 to provide sufficient structural support to the die insert 510. Similarly, a lower density of holes 530, 535, may allow for a thinner die housing 520.

Two Piece Housing

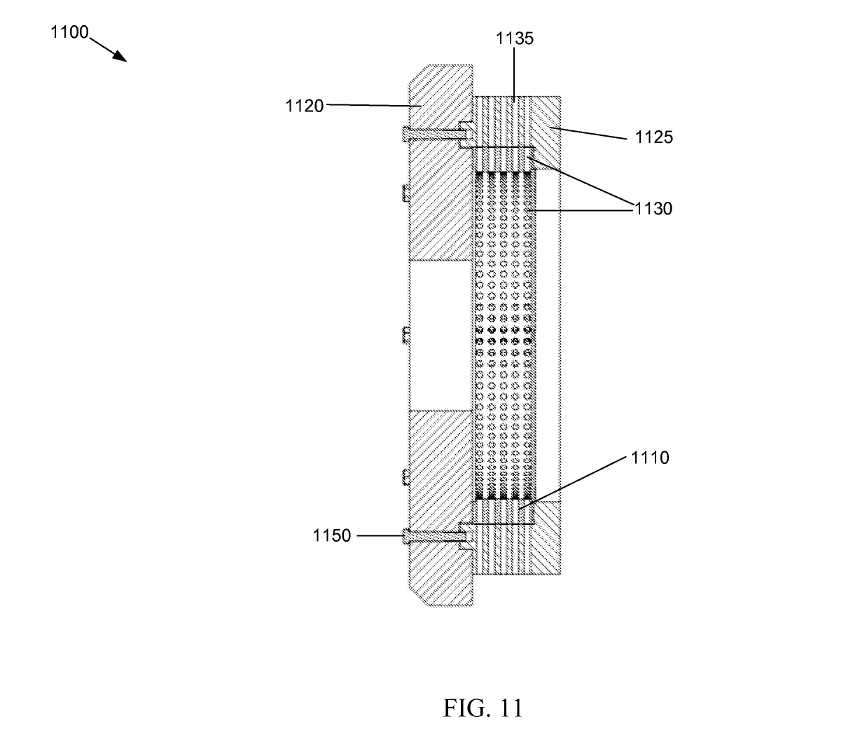

FIG. 11 is a sectional schematic diagram of a fourth embodiment of an extrusion die 1100. Under the fourth embodiment, a die housing may include a die hub 1120 and a die housing ring 1125. The die housing ring 1125 may be partially inset into a ring shaped slot in the die hub 1120, and the die housing ring 1125 may be fastened to the die hub 1120 using, for example, one or more bolts 1150, or by threading the die housing ring into the ring shaped slot in the die hub 1120.

Under the fourth embodiment, a die insert 1110 may be at least partially retained against the die hub 1120 by the die housing ring 1125. Under the fourth embodiment, the die housing ring 1125 may be removed to replace the die insert 1110. Material is forced through extrusion holes 1130 in the die insert 1110, passing through extension holes 1135 in the die housing ring 1125.

Extrusion Holes

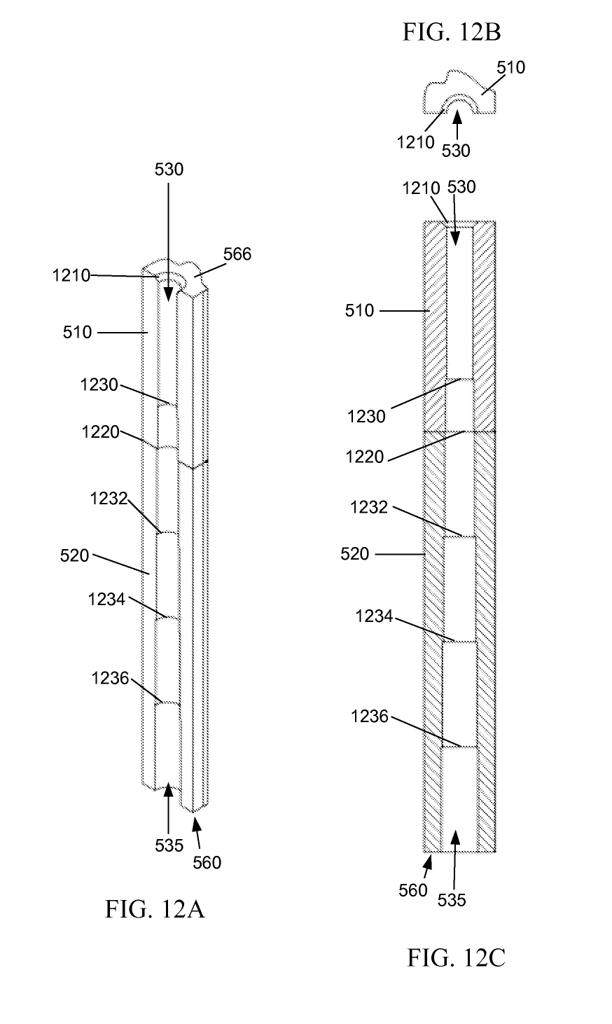

A detail of the extrusion holes 530 and extension holes 535 is shown in FIGS. 12A-12C.

FIG. 12A shows a single bisected extrusion hole 530/extension hole 535 pair from a sectional view, FIG. 12B shows a top view of a bisected extrusion hole 530, and FIG. 12C shows a single bisected extrusion hole 530/extension hole 535 pair from a sectional view. The extrusion holes 530 are generally narrower at the die insert 510 extrusion surface 564 than at the die housing 520 exterior surface 560. The holes 530, 535 may widen in one or more steps as shown. Alternatively, the holes 530, 535, may widen through a taper, or widen through a combination of steps and tapers, to ensure plug free operation.

In general, the extrusion holes 530 are substantially circular in cross sectional shape, and have a first diameter for a first segment of the extrusion hole 530. The first segment begins substantially at the extrusion surface 566, and ends at a first step 1230. The first segment maintains the first diameter throughout the length of the first segment. The length of the first segment may be determined to facilitate plug-free formation of pellets, as familiar to persons having ordinary skill in the art. At the end of the first segment, the extrusion hole 530 widens to a second diameter for a second segment at the first step 1230. The second diameter is larger than the first diameter. The diameter of the second segment may remain constant as the second diameter, or may taper from the second diameter to a third diameter at an interface 1220 between the die insert 510 and the die housing 520.

Each extension hole 535 in the die housing 520 may generally have a fourth diameter at the interface 1220, where the fourth diameter is generally larger than the third diameter. The larger fourth diameter of the extension holes 535 in relation to the smaller third diameter of extrusion holes 530 may serve to avoid the plugging of extruded material, and may also serve to provide some tolerance in axial alignment between the extrusion holes 530 and extension holes 535. This tolerance is to allow extruded material to pass from the extrusion holes 530 to the extension holes 535 even if the die insert 510 is slightly misaligned with the die housing 520. The extension holes 535 may have a fifth diameter at the die housing exterior surface 560, where the fifth diameter is equal to or larger than the fourth diameter. The extension holes 535 may gradually widen through a series of steps 1232, 1234, 1236, as shown, or through a taper. There may be an ingress taper 1210 around the rim where the extrusion hole 530 meets the extrusion surface 566.

Flat Die Embodiment

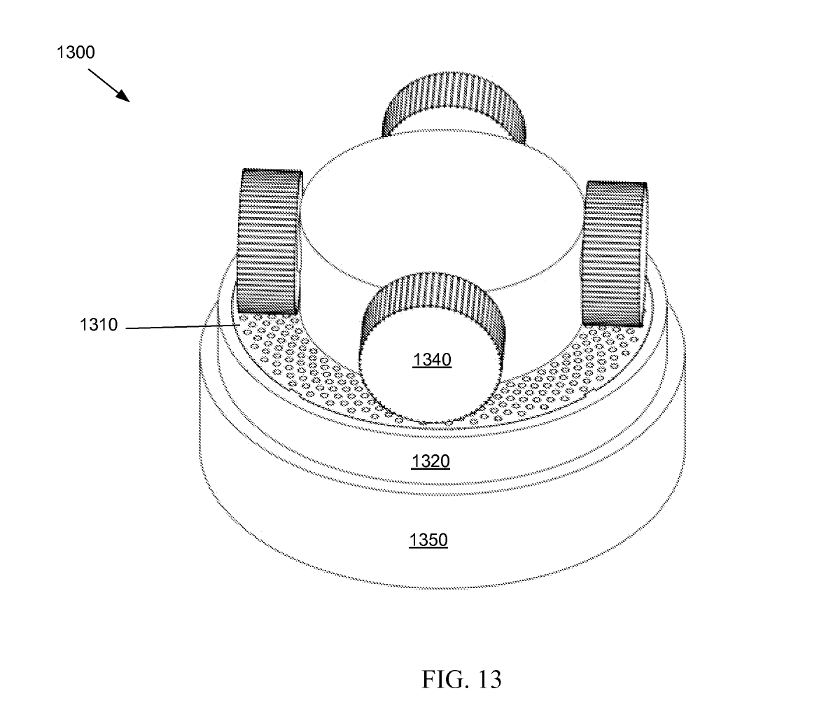

As noted above, while the first, second, third, and fourth embodiments of a die housing and die insert are based on a ring die, there is no objection to embodiments of a die housing and die insert with other die configurations. For example, a fifth embodiment of an extrusion die 1300 is a flat die shown in FIG. 13. The die housing 1320 may be generally pan shaped, and configured to receive a substantially disc-ring shaped die insert 1310. The die housing 1320 may rest upon a base 1350. One or more rolls 1340 rotate over the extrusion surface of the flat die 1300, compressing material between the rolls 1340 and the die insert 1310 extrusion surface, thereby forcing material into the extrusion holes 1330.

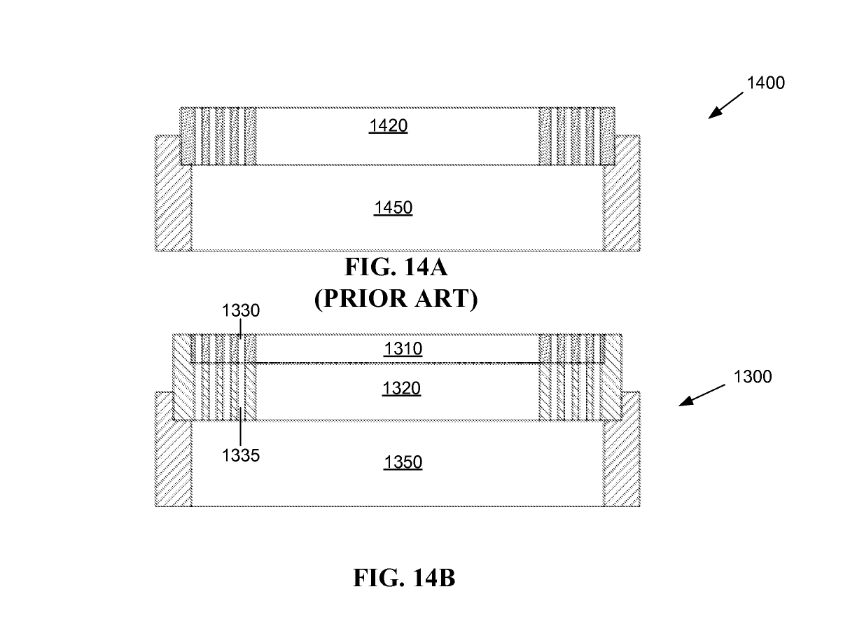

Turning to FIG. 14B, showing the fifth embodiment in cross sectional view, the die insert 1310 includes a plurality of extrusion holes 1330, each extrusion hole 1330 axially aligning with an extension hole 1335 passing through the die housing 1320. Pellet material is formed into pellets in the extrusion holes 1330, thereafter passing the extruded pelletized material through the extension holes 1335.

FIG. 14A shows a prior art flat die 1400 with an extrusion disc 1420 for purposes of comparison with the fifth embodiment 1300 shown in FIG. 14B. Unlike the fifth embodiment, the extrusion disc 1420 is substantially formed of a single material, and therefore is generally replaced in its entirety when worn, damaged or broken. In contrast, at such time when the die insert 1310 needs to be replaced, only the die insert 1310 itself is replaced by removing the previous die insert 1310 from the die housing 1320, and replacing it with a replacement die insert 1310.

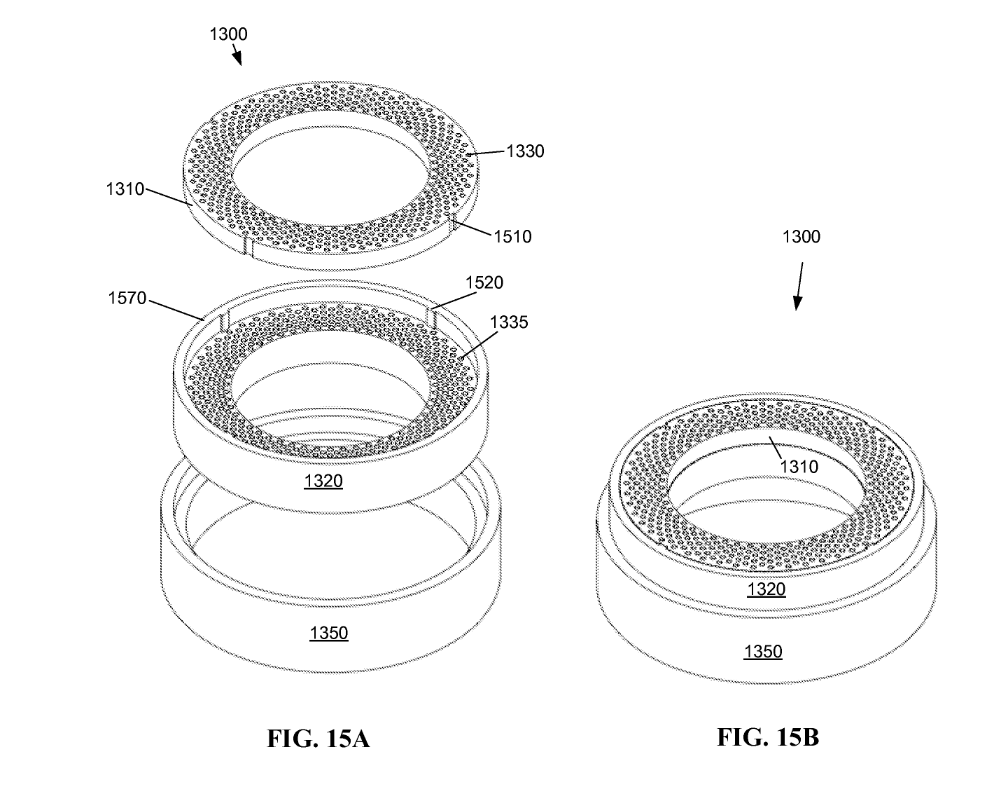

FIG. 15A shows the fifth embodiment of an extrusion die 1300 in exploded form, while FIG. 15B shows the fifth embodiment of the extrusion die 1300 substantially as assembled. The extrusion holes 1330 and the extension holes 1335 may be aligned using a key tab 1520 extending radially inward from a rim 1570 of the die housing 1320, corresponding to a key slot 1510 in the edge of the die insert 1310. Other means of aligning the die housing 1320 with the die insert 1310 may be similar to alignment means discussed above regarding the ring die embodiments, and may therefore be applicable to the fifth embodiment, for example, using key ridges and key slots, or pins and pin holes.

As with the ring die embodiments, the fifth embodiment may have tapered or stepped extrusion holes 1330 and extension holes 1335, wherein the diameter of the extrusion holes 1330 is smaller than the diameter of the extension holes 1335 to avoid plugging and to provide generous tolerances for axial alignment between extrusion holes 1330 and extension holes 1335. Similarly, the thickness of the die housing 1320 may be different from the thickness of the die insert 1310.

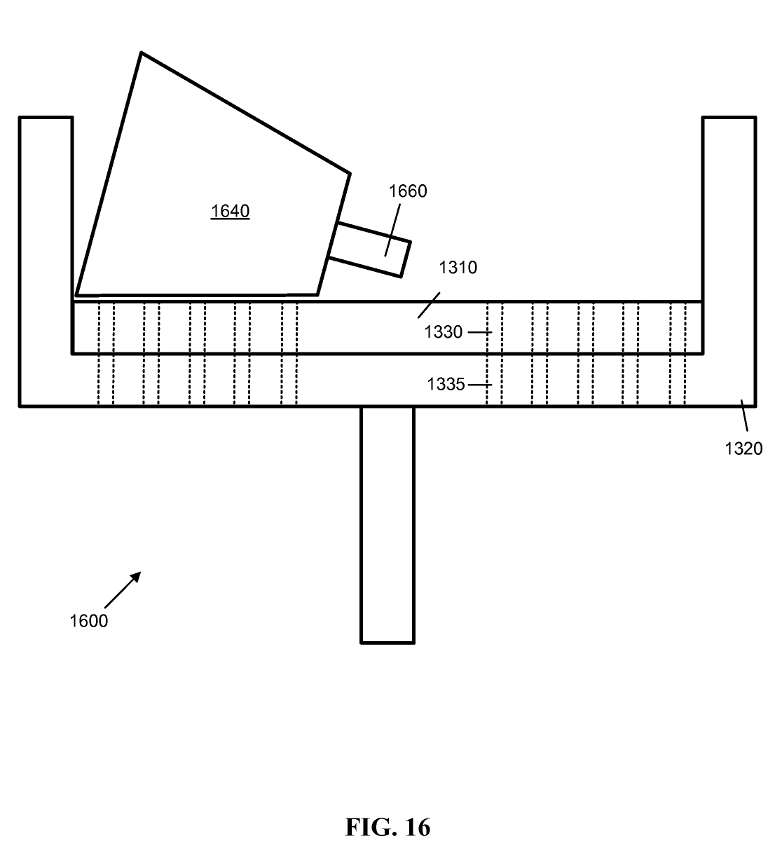

FIG. 16 shows a sixth embodiment of an extrusion die with a tapered roll 1640. While the roll 1340 (FIG. 13) has been depicted as substantially cylindrical in shape, there is no objection to variations on the shape of the roll 1340 (FIG. 13), for example a conical shaped roll 1640. Similarly, there is no objection to a die housing with a die insert where the die insert extrusion surface is tapered, wherein an inner diameter of the extrusion surface is smaller than and outer diameter of the extrusion surface.

In summary, embodiments of an extrusion die housing with a removable and replaceable die insert have been presented. The die insert is received by the die housing, such that the extrusion surface of the die insert is entirely supported by the die housing. Material from inside the die is compressed by rolls located generally on the interior of the die, so that compressed material is forced through extrusion holes in the die insert, thereafter passing through extension holes in the die housing, where the extension holes axially align with the extrusion holes.

It will be apparent to those skilled in the art that various modifications and variations can be made to the structure of the present invention without departing from the scope or spirit of the invention. For example, while the die insert has been generally described as being removable and replaceable, there is no objection to an embodiment where the die insert binds to the die housing in a non-removable fashion. In view of the foregoing, it is intended that the present invention cover modifications and variations of this invention provided they fall within the scope of the following claims and their equivalents.

What is claimed is:

1. A method for manufacturing an extrusion die, comprising the steps of:
forming a die housing having an exterior surface and an inner interface surface; and
forming a die insert having an outer interface surface and an extrusion surface, said die housing configured to removably receive said die insert so that said outer interface surface is adjacent to said inner interface surface,
wherein said inner interface surface is configured to substantially enclose said outer interface surface.

2. The method of claim 1, further comprising the steps of:
forming a plurality of extension apertures between said exterior surface and said inner interface surface; and
forming a plurality of extrusion apertures between said outer interface surface and said extrusion surface; wherein said plurality of extension apertures substantially axially align with said plurality of extrusion apertures.

3. The method of claim 2, further comprising the step of keying said die insert outer interface surface with said die housing inner interface surface.

4. The method of claim 1, wherein said extrusion die comprises a ring die.

5. The method of claim 1, wherein said die housing insert comprises a high chrome stainless steel alloy.

6. The method of claim 1, wherein said die housing insert comprises carbon alloy steel.

7. The method of claim 6, wherein said carbon alloy steel comprises 4140 steel.

8. The method of claim 1, wherein:
said die housing insert comprises a first steel alloy; and
said die housing insert comprises a second steel alloy,
wherein said first steel alloy and said second steel alloy have generally proportional thermal expansion rates.

9. The method of claim 2, further comprising the step of forming a key configured to affix said die insert with respect to said die housing, wherein said extrusion apertures are disposed substantially in axial alignment with said extension apertures.

10. The method of claim 9, wherein said key further comprises:
a protruding member; and
a receiving member configured to receive said protruding member.

11. The method of claim 10, wherein said key further comprises a removable pin.

12. The method of claim 10, wherein said key further comprises a bolt.

13. The method of claim 10, wherein said extrusion die is a ring die, and wherein and said die insert rotates in rigid accompaniment with said die housing.

14. The method of claim 10, wherein said extrusion die comprises a flat die.

15. A method for manufacturing an extrusion die insert configured to be removably received by a die housing having an exterior surface and an inner interface surface, comprising the steps of:
forming a die insert having an outer interface surface and an extrusion surface, said die housing configured to removably receive said die insert so that said outer interface surface is adjacent to said inner interface surface; and
forming a plurality of extrusion apertures between said outer interface surface and said extrusion surface; wherein said plurality of extension apertures align with a plurality of extrusion apertures formed in said die housing.

16. A method for servicing an extrusion die, the extrusion die comprising a die housing having an exterior surface and an inner interface surface, the die housing configured to removably receive a die insert, and a first die insert having an outer interface surface and an extrusion surface, the first die insert disposed within said die housing so that said outer interface surface is adjacent to said inner interface surface, comprising the steps of:
replacing said first die insert in said die housing by removing said first die insert from said die housing; and
installing a second die insert into said die housing.

17. The method of claim 16, wherein said second die insert comprises characteristics more favorable to a specific extrusion material with respect to said first die insert.

18. The method of claim 17, wherein said second die insert different extrusion hole sizes than the first die insert.

19. The method of claim 17, wherein said second die insert different extrusion hole tapers than the first die insert.
